(19) United States
(12) Patent Application Publication
(10) Pub. No.: US 2026/0135493 A1
(43) Pub. Date: May 14, 2026

(54) MODULATION CONTROL SYSTEM FOR A POWER ELECTRONIC CONVERTER

(71) Applicant: Eaton Intelligent Power Limited, Dublin (IE)

(72) Inventors: Mostafa Abarzadeh Bayrami, Menomonee Falls, WI (US); Hua Qiang Li, Menomonee Falls, WI (US); Thomas M. Ruchti, Pewaukee, WI (US)

(21) Appl. No.: 18/947,942

(22) Filed: Nov. 14, 2024

(51) Int. Cl. H02M 5/458; H02M 1/08; H02M 1/12

(52) U.S. Cl. CPC H02M 5/458; H02M 1/08; H02M 1/12

(57) ABSTRACT

A system includes: a power electronic converter including controllable electronic switches; and a control apparatus configured to: determine a range of carrier frequencies based on a main carrier frequency and a spread factor, where the spread factor is a value that is not equal to one; generate a control signal including a variable switching frequency, where the variable switching frequency has a first switching frequency value in a range of carrier frequencies, and, after a pre-determined number of cycles at the first switching frequency value, the variable switching frequency has a second switching frequency value in the range of carrier frequencies; and provide the control signal to the power electronic converter such that the controllable electronic switches change state at the variable switching frequency.

### TECHNICAL FIELD

This disclosure relates to a modulation control system for a power electronic converter.

### BACKGROUND

A power electronic converter, such as a variable speed drive (VSD), an adjustable speed drive (ASD), or an uninterruptable power supply, may be connected to an alternating current (AC) high-power electrical distribution system, such as a power grid. The electrical apparatus drives, powers, and/or controls a machine, or a non-machine type of load and can also convert direct current (DC) power to AC power. The source of DC power can be, for example, energy storage, batteries, photovoltaic (PV) solar and/or other renewable sources, or another AC to DC power converter. The power electronic converter includes an electrical network that converts DC power to AC power and also may convert AC power to DC power.

### SUMMARY

In one aspect, a system includes: a power electronic converter including controllable electronic switches; and a control apparatus configured to: determine a range of carrier frequencies based on a main carrier frequency and a spread factor, where the spread factor is a value that is not equal to one; generate a control signal including a variable switching frequency, where the variable switching frequency has a first switching frequency value in a range of carrier frequencies, and, after a pre-determined number of cycles at the first switching frequency value, the variable switching frequency has a second switching frequency value in the range of carrier frequencies; and provide the control signal to the power electronic converter such that the controllable electronic switches change state at the variable switching frequency.

Implementations may include one or more of the following features.

The spread factor may be a value that is less than one and the pre-determined number of cycles is greater than one.

The range of carrier frequencies may be centered on the main carrier frequency.

The first switching frequency value and the second switching frequency value may be different.

In some implementations, the control apparatus is further configured to: determine the first switching frequency value by randomly selecting a first frequency in the range of frequencies; and determine the second switching frequency value by randomly selecting a second frequency in the range of frequencies.

The power electronic converter may include a variable frequency drive.

The power electronic converter may include a multi-level converter.

The power electronic converter may include a two-level converter.

The control apparatus may be further configured to: access a value representing an acceptable spread energy band of one or more harmonics of an output voltage of the power electronic converter; and determine the spread factor and the pre-determined number of cycles based on the main carrier frequency and the value representing the acceptable spread energy band.

The power electronic converter may include a rectifier, a DC link, and an inverter.

In another aspect, a modulation control system for a power electronic converter is configured to: generate a control signal including a variable switching frequency, where the variable switching frequency has a first switching frequency value in a range of carrier frequencies, and, after a pre-determined number of cycles that is greater than one, the modulation control system is configured to set the variable switching frequency to a second switching frequency value in the range of carrier frequencies, and where the range of carrier frequencies is based on a spread factor and a main carrier frequency.

Implementations may include one or more of the following features.

The modulation control system may be further configured to provide the control signal to a power electronic converter such that controllable electronic switches in the power electronic converter change state at the variable switching frequency.

The modulation control system may be further configured to determine the range of carrier frequencies based on the main carrier frequency and the spread factor, and where the spread factor is value that is not equal to one.

The spread factor may be a value that is less than one and the pre-determined number of cycles is greater than one.

The modulation control system may be further configured to: access a value representing an acceptable spread energy band of one or more harmonics of an output voltage of the power electronic converter; and determine the spread factor and the pre-determined number of cycles based on the main carrier frequency and the value representing the acceptable spread energy band.

In another aspect, a method of decreasing noise in an output voltage of an inverter at one or more target frequencies includes: accessing one or more target frequency values; accessing a value representing an acceptable spread energy band at the one or more target frequency values; determining a spread factor and cycle count (k) based on a main carrier frequency and the value representing the acceptable spread energy band; generating a control signal for an inverter, the control signal including a variable switching frequency that changes each cycle count (k) repetitions based on the spread factor and a main carrier frequency; and providing the control signal to the inverter to thereby decrease the noise in the output voltage of the inverter at the one or more target frequencies.

Implementations may include one or more of the following features.

At least one of the one or more of the target frequency values may be less than 150 KHz.

At least one of the one or more of the target frequency values may be between 20 kHz and 150 kHz.

At least one of the one or more of the target frequency values is between 2 kHz and 150 kHz.

Implementations of any of the techniques described herein may include an apparatus, a device, a system, a modulation control system, machine-executable instructions, and/or a method. The details of one or more implementations are set forth in the accompanying drawings and the description below. Other features will be apparent from the description and drawings, and from the claims.

### DRAWING DESCRIPTION

FIG. 1 is a block diagram of an example of a system that includes a power electronic converter.

FIG. 2 is a schematic of another example of a system that includes a power electronic converter.

FIG. 3 is a block diagram of an example of a control scheme.

FIG. 4 is a flow chart of an example of a process for generating a control signal based on a 2D-RSF-PWM control scheme.

FIG. 5A shows an example of a 2D-RSF-PWM carrier waveform and reference waveform over time.

FIG. 5B shows an example of a control signal over time.

FIG. 6 is a flow chart of an example of a process for reducing noise in the output of an inverter by controlling the inverter with a 2D-RSF-PWM approach.

FIG. 7 is plot of amplitude of output voltage noise spikes as a function of frequency for a conventional SPWM approach (dashed line), a conventional RSF-PWM approach (dash-dot line), and the 2D-RSF-PWM approach (solid line).

FIG. 8 is a schematic of an example of a variable frequency drive (VFD).

FIGS. 9 and 10 are examples of experimental data.

### DETAILED DESCRIPTION

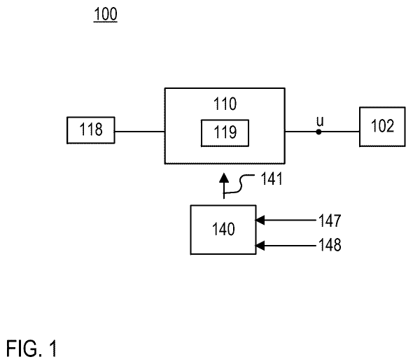

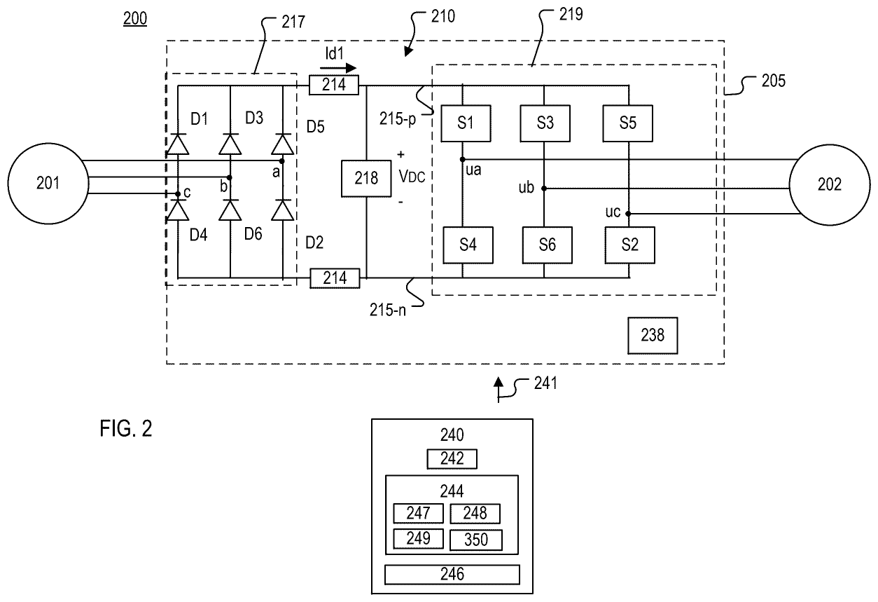

FIG. 1 is a block diagram of an example of a power system 100. The power system 100 includes a converter 110 electrically connected to direct current (DC) source 118 and a load 102. The load 102 is any type of device or system that utilizes, transfers, absorbs, or distributes time-varying (or AC) electricity. The load 102 may be, for example, a motor (such as an induction motor), a lighting system, a machine, or a generator. The load 102 may take other forms. For example, the load 102 may be an AC power grid, an AC to DC power converter, or an AC to AC power converter, just to name a few. The DC source 118 is any type of source of DC electrical power. For example, the source 118 may be a capacitor, a network of capacitors, or a battery. The source 118 may be a DC link of an AC-DC-AC power converter (such as the power electronic converter 210 shown in FIG. 2) or an output of an AC to DC power converter.

The converter 110 includes power electronic switches 119. The power electronic switches 119 are any kind of controllable switch that have at least two stable states, an ON state in which current can flow in the switch and an OFF state in which current cannot flow in the switch. For example, the electronic switches 119 may be transistors. The converter 110 receives a control signal 141 from a modulation control system 140. The control signal 141 includes gating commands or switching information that cause the electronic switches 119 to switch ON and OFF over time in a switching pattern to generate a voltage (u) that is available to the load 102. The frequency at which the switches 119 transition from ON to OFF or vice versa is the switching frequency (fs). The voltage (u) varies over time with characteristics (for example, amplitude, frequency, and/or phase) that are determined by the switching pattern of the electronic switches 119. Thus, by controlling the features of the control signal 141, the characteristics of the voltage (u) are also controlled.

As discussed in greater detail below, the modulation control system 140 implements a two-dimensional (2D) random switching frequency (RSF) pulse width modulation (PWM) technique to generate the control signal 141. In the 2D-RSF-PWM technique, the switching frequency (fs) is randomly varied within a band of frequencies around a main carrier frequency (fc) and is changed after a certain number of cycles or repetitions of the switching frequency (fs). The band of frequencies is referred to as the spread factor (δ) 147 and the certain number of repetitions is referred to as the number of repetitions (k) 148. The spread factor (δ) 147 and the number of repetitions (k) 148 are parameters of the modulation control system 140. The spread factor (δ) 147 provides a defined frequency band for the switching frequency, and the number of repetitions (k) 148 provides the rate at which the switching frequency changes. By adjusting the spread factor (δ) 147 and the number of repetitions (k) 148, the noise in the voltage (u) is reduced as compared to conventional PWM approaches. For example, by optimizing and/or adjusting the spread factor (δ) 147 and the number of repetitions (k) 148, electromagnetic interference (EMI) at higher frequencies (for example, 150 kilohertz (kHz) to 30 megahertz (MHz)) and switching noise at lower frequencies (for example, 2 kHz to 150 kHz) is reduced as compared to conventional PWM approaches.

FIG. 2 is a schematic of a system 200. The system 200 includes a power electronic converter 210 that is connected to a three-phase AC electrical power source 201 and to a three-phase load 202. The power electronic converter 210 may be, for example, a variable frequency drive (VFD) or an adjustable speed drive (ASD). The power electronic converter 210 includes a rectifier 217, an inverter 219, and a DC link 218 electrically connected to the rectifier 217 and the inverter 219. The power electronic converter 210 includes a positive DC bus 215-p and a negative DC bus 215-n, and the DC link 218 is connected to the positive DC bus 215-p and the negative DC bus 215-n. The system 200 also includes a modulation control system 240 that controls the inverter 219 based on a control scheme 350 that implements the 2D-RSF-PWM approach. An overview of the system 200 is provided prior to discussing the control scheme 350 in more detail.

The load 202 is any three-phase load. For example, the load 202 may be a three-phase motor, such as an induction motor or a permanent magnet synchronous machine, an AC power grid, an AC-to-DC power converter, or an AC-to-AC power converter, just to name a few. The source 201 is a three-phase AC source with phases a, b, c. For example, the source 201 may be a node in an electrical power distribution network that distributes three-phase AC electrical power having a fundamental frequency of, for example, 50 or 60 Hertz (Hz). The distribution network may have an operating voltage of up to 38 kV. The distribution network may include, for example, one or more transmission lines, distribution lines, electrical cables, and/or any other mechanism for transmitting electricity. In some implementations, the system 200 includes a step-down transformer between the source 201 and the power electronic converter 210 to, for example, reduce the voltage provided to the power electronic converter 210 to 690V or less. The source 201 may take other forms. For example, the source 201 may be a generator, a renewable energy resource, or a transformer.

The rectifier 217 is a three-phase six-pulse bridge that includes six electronic switches. In the example of FIG. 2, the six electronic switches are diodes D1 to D6. Each diode D1 to D6 includes a cathode and an anode and is associated with a forward bias voltage. Current can flow through a diode in the forward direction (from the anode to the cathode) when the voltage of the anode is greater than the voltage of the cathode by at least the bias voltage. When the voltage difference between the anode and the cathode is less than the forward bias voltage, the diode does not conduct current in the forward direction.

Phase a of the source 201 is electrically connected to the anode of the diode D1 and the cathode of the diode D4. Phase b of the source 201 is electrically connected to the anode of the diode D3 and the cathode of the diode D6. Phase c of the source 201 is electrically connected to the anode of the diode D5 and the cathode of the diode D2. The diodes D1 to D6 rectify the AC input currents ia, ib, ic from the source 201 into a DC current id1.

The diodes D1 to D6 are also electrically connected to the DC link 218 through choke inductors 214. The DC link 218 includes one or more devices that are configured to store electrical energy. For example, the DC link 218 may be a capacitor or a network of capacitors. The inverter 219 converts the DC power stored in the DC link 218 into a three-phase AC voltage (ua, ua, ua) that is available for the load 202. The inverter 219 includes a network of electronic switches S1 to S6 that are controlled by the modulation control system 240 to generate the AC voltages. Each of the switches S1 to S6 may be, for example, a power transistor.

The inverter 219 and/or the rectifier 217 may take other forms. For example, the rectifier 217 may be an active front end (AFE) that includes controllable switches (such as transistors) instead of the diodes D1 to D6. The inverter 219 also may take other forms.

Additionally, although the power electronic converter 210 is an AC-DC-AC power converter, the power electronic converter 210 may be configured in another manner. For example, the power electronic converter 210 may be a DC-to-AC power converter that lacks the rectifier 217.

The system 200 also includes a sensor system 238 that measures and/or estimates properties or parameters. For example, the sensor system 238 may include current sensors that measure the amount of current drawn in each phase of the load 202, the currents at the outputs of the inverter 219, voltage sensors that measure the voltages ua, ub, uc at the output of the inverter 219 and/or voltage sensors that measure the voltage across each DC link 218. The system 200 may include other components and features. For example, the power electronic converter 210 may include an L-C or L-C-L filter between the rectifier 217 and the source 201.

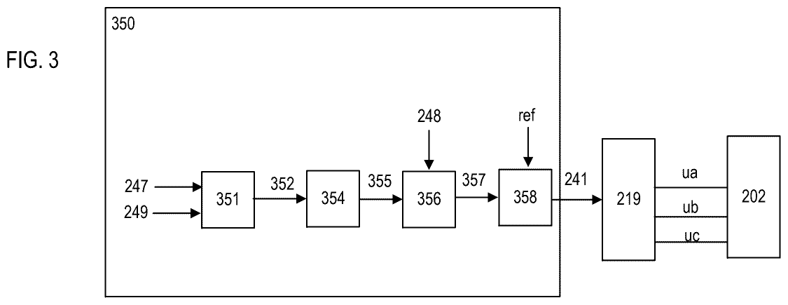

The modulation control system 240 generates a control signal 241, which, when applied to the inverter 219, controls the switching pattern of the switches S1 to S6 to generate AC voltages ua, ub, uc with particular characteristics (for example, amplitude, frequency, and/or phase). The modulation control system 240 generates the control signal 241 using the control scheme 350, which is discussed with respect to FIG. 3.

The modulation control system 240 includes an electronic processing module 242, an electronic storage 244, and an input/output (I/O) interface 246. The electronic processing module 242 includes one or more electronic processors. The electronic processors of the module 242 may be any type of electronic processor and may or may not include a general-purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 244 is any type of electronic memory capable of storing data and instructions in the form of computer programs or software, and the electronic storage 244 may include volatile and/or non-volatile components. The electronic storage 244 and the processing module 242 are coupled such that the processing module 242 is able to access or read data from and write data to the electronic storage 244. The electronic storage 244 stores information for use in the control scheme 350. For example, the electronic storage 244 stores a spread factor (δ) 247, a number of repetitions (k) 248, and a nominal carrier frequency (fc) 249 as numerical values.

The electronic storage 244 also stores instructions that, when executed, cause the electronic processing module 242 to perform the control scheme 350, analyze data, and/or retrieve information. The electronic storage 244 also may include executable instructions to implement various transformations, such as, for example, the Clarke transformation, the Park transformation, and inverse versions of these transformations. Moreover, although the electronic storage 244 stores electronic instructions to implement the control scheme 350 and the 2D-RSF-PWM approach, the electronic storage 244 also may store instructions to implement any known PWM approach, such as sinusoidal PWM (SPWM) and random switching frequency PWM (RSF-PWM).

The I/O interface 246 may be any interface that allows a human operator and/or an autonomous process to interact with the modulation control system 240. The I/O interface 246 may include, for example, a display (such as a liquid crystal display (LCD)), a keyboard, audio input and/or output (such as speakers and/or a microphone), visual output (such as lights, light emitting diodes (LED)) that are in addition to or instead of the display, serial or parallel port, a Universal Serial Bus (USB) connection, and/or any type of network interface, such as, for example, Ethernet. The I/O interface 246 also may allow communication without physical contact through, for example, an IEEE 802.11, Bluetooth, or a near-field communication (NFC) connection. The modulation control system 240 may be, for example, operated, configured, modified, or updated through the I/O interface 246. Additionally, information used in the control scheme 350, such as values for the spread factor (δ) 247 and number of repetitions (k) 248, may be entered via the I/O interface 246.

The I/O interface 246 also may allow the modulation control system 240 to communicate with components in the system 200 and with systems external to and remote from the system 200. For example, the I/O interface 246 may control a switch or a switching network (not shown) or a breaker within the system 200 that allows the power electronic converter 210 to be disconnected from the source 201. In another example, the I/O interface 246 may include a communications interface that allows communication between the modulation control system 240 and a remote station (not shown), or between the modulation control system 240 and a separate monitoring apparatus. The remote station or the monitoring apparatus may be any type of station through which an operator is able to communicate with the modulation control system 240 without making physical contact with the modulation control system 240. For example, the remote station may be a computer-based work station, a smart phone, tablet, or a laptop computer that connects to the modulation control system 240 via a services protocol, or a remote control that connects to the modulation control system 240 via a radio-frequency signal.

FIG. 3 is a block diagram of the control scheme 350. The control scheme 350 implements 2D-RSF-PWM to generate the control signal 241 for the inverter 219. The control scheme 350 includes a frequency range generator 351, which determines a range of frequencies 352 based on the spread factor (δ) 247 and the nominal carrier frequency (fc) 249. The frequency range generator 351 implements Equations (1) to (3) to determine the range of frequencies 352:

$$Δ fc = δ fc , \qquad Equation ( 1 )$$

where Δfc is the bandwidth of the range of frequencies 352, δ is the spread factor (δ) 247, and fc is the nominal carrier frequency (fc) 249. The spread factor (δ) 247 is a positive and dimensionless numerical value that is less than 1. The nominal carrier frequency (fc) 249 is the nominal switching frequency and may be, for example, between 9 kHz and 100 kHz. The value of the nominal carrier frequency (fc) 249 may be set by the operator of the modulation control system 240. The bandwidth of the range of frequencies 352 and the nominal carrier frequency (fc) are numerical values with units of Hertz (Hz). The frequency range generator 351 also determines a minimum frequency (fmin) and a maximum frequency (fmax) based on Equations (2a) and Equation (2b), respectively:

$$f min = fc - \frac{1}{2} Δ fc , \qquad Equation ( 2 a )$$

$$f max = fc + \frac{1}{2} Δ fc . \qquad Equation ( 2 b )$$

The range of frequencies 352 are those frequencies between fmin and fmax.

The range of frequencies 352 is provided to a frequency selector 354, which selects a frequency in the range of frequencies 352 at random and outputs the randomly selected frequency as the switching frequency (fs) 355. The switching frequency (fs) 355 is provided to a carrier signal generator 356. The carrier signal generator 356 generates a time-varying carrier waveform 357 that has a fundamental frequency at the switching frequency (fs) 355 for a time duration (Ts). The time duration (Ts) depends on the number of repetitions (k) 248 and is determined based on Equation (3):

$$Ts = \frac{k}{{f}_{s}} , \qquad Equation ( 3 )$$

where fs is the currently selected switching frequency in units of Hertz (Hz), k is the number of repetitions (k) 248 and is a dimensionless integer number that is greater than 1, and Ts is the duration in units of seconds(s). The carrier waveform 357 may be, for example, a triangle wave. The carrier waveform 357 is compared to a reference wave (ref) at a comparator 358 to produce the control signal 241.

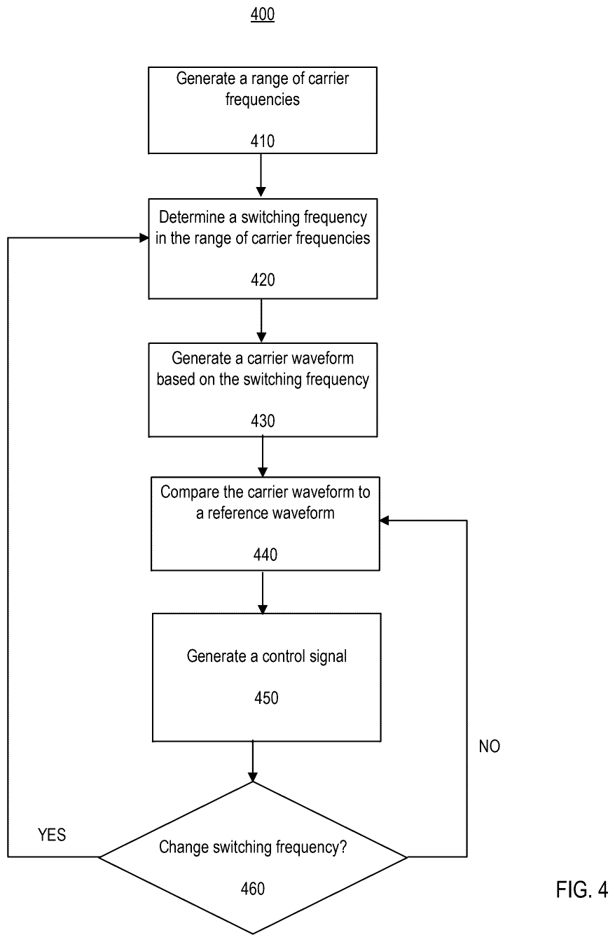

Referring also to FIG. 4, a flow chart of a process 400 for generating the control signal 241 based on the 2D-RSF-PWM control scheme 350 is shown.

The range of frequencies 352 is determined (410) at the frequency range generator 351 based on Equations (1), (2a), and (2b) shown above. The determined range of frequencies 352 may be stored on the electronic storage 244. A switching frequency (fs1) is determined (420) at the frequency selector 354. The frequency selector 354 implements a random or pseudo random process to select one frequency in the range of frequencies 352 as the switching frequency (fs1). For example, the frequency selector 354 may implement a random number generator that takes the maximum frequency (fmax) and minimum frequency (fmin) determined in Equations (2a) and (2b) as inputs and returns a random value that is in the range of frequencies 352. In this implementation, the random value is used as the switching frequency (fs1). In some implementations, the frequency selector 354 selects the switching frequency (fs1) from a normally distributed randomly generated arrays of switching frequencies between fmin and fmax from equations (2a) and (2b).

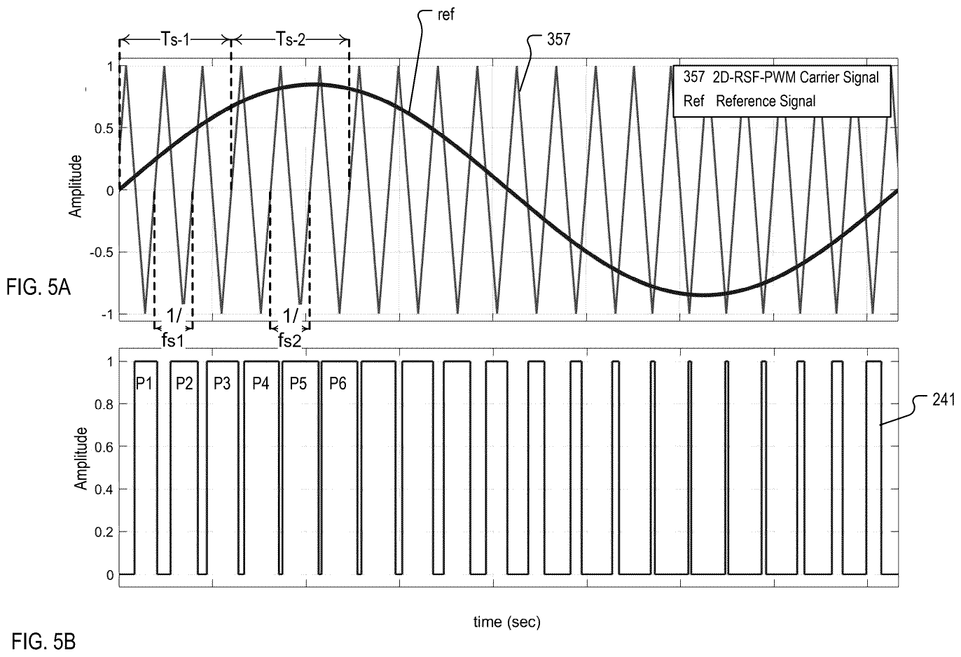

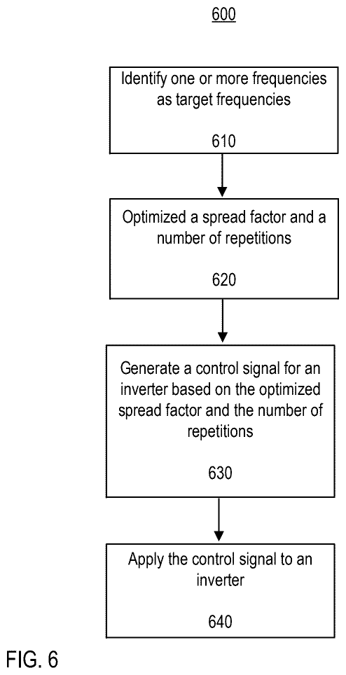

The carrier waveform 357 is generated (430) at the carrier signal generator 356. The carrier waveform 357 is a time-varying waveform that has a fundamental frequency at the switching frequency (fs1). FIG. 5A shows the amplitude of the carrier waveform 357 as a function of time in an example in which the carrier waveform 357 is a triangle wave having a fundamental frequency of fs1 during a time period labeled Ts-1. The time period Ts-1 has a duration determined by Equation (3). In the example shown in FIG. 5A, the number of repetitions (k) 248 was equal to 3.

The carrier waveform 357 is compared to the reference waveform (ref) at the comparator 358 (440). FIG. 5A also shows the reference waveform (ref). The reference waveform (ref) is a time-varying waveform that has a fundamental frequency at the operating frequency of the load 202. For example, the fundamental frequency of the reference waveform (ref) may be 60 Hz. The operating frequency of the load 202 may be much less than the frequencies in the range of frequencies 352.

The control signal 241 is generated (450) based on the comparison. When the amplitude of the reference waveform (ref) is greater than the amplitude of the carrier waveform 357, the control signal 241 is HIGH (1 in the example of FIG. 5B). When the amplitude of the reference waveform (ref) is less than the carrier waveform 357, the control signal 241 is LOW (0 in the example of FIG. 5B). The comparison at (450) continues until the pre-determined number of repetitions (k) have occurred (460). FIG. 5B is an example of the amplitude of the control signal 241 over the same time scale as FIG. 5A. In the example of FIG. 5A, gating pulses P1, P2, P3 are generated as a result of the comparison of the reference waveform (ref) to the carrier waveform 357 during the time period Ts-1.

The process 400 determines whether the number of repetitions (k) 248 of the switching frequency (fs1) have occurred at (460). If k repetitions (or cycles) of the switching frequency (fs1) have occurred, the process 400 returns to (420) to select a new switching frequency (fs2) from the range of frequencies 352. The carrier waveform 357 is re-generated or adjusted to have the switching frequency (fs2) as the fundamental frequency (430) over the time period Ts-2. The time period Ts-2 is determined based on Equation (3). Because the switching frequencies (fs1) and (fs2) are not necessarily the same, the time periods Ts-1 and Ts-2 may be different. The adjusted carrier waveform 357 is compared to the reference waveform (ref) to generate pulses P4, P5, P6 of the control signal 241. Thus, the switching frequency (fs) 355 changes or is updated randomly within the band of frequencies 352 after k cycles of the current switching frequency. In this way, the switching frequency (fs) is variable and is not constant.

The process 400 continues to select a different switching frequency (fs) 355 at the rate dictated by the number of repetitions (k) 248, generate a carrier waveform 357 at the selected switching frequency (fs), and generate the control signal 241 by performing (430) to (450) until the process 400 ends. The process 400 may end, for example, when the inverter 219 and/or the modulation control system 240 are turned off or otherwise taken out of service.

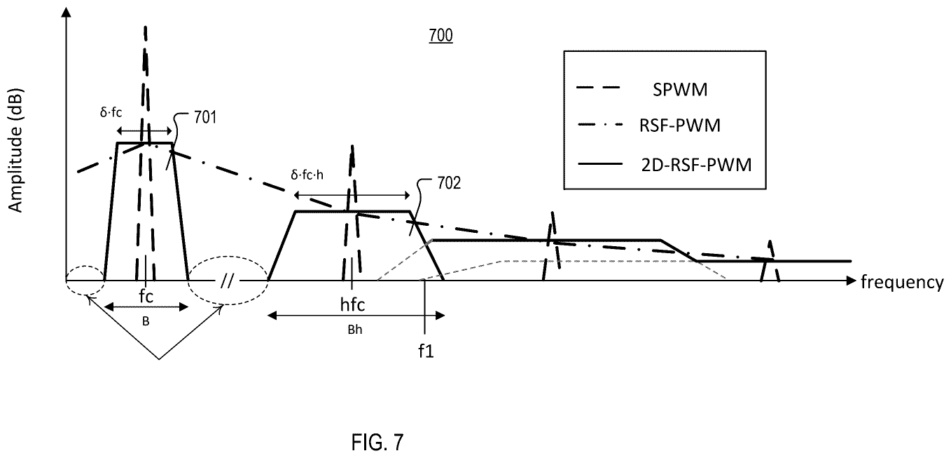

FIG. 6 is a flow chart of a process 600 for reducing noise in the output of an inverter by controlling the inverter with the 2D-RSF-PWM approach. In conventional sinusoidal PWM (SPWM), controllable switches in an inverter are controlled based on a gating signal that is generated by comparing a sinusoidal reference signal to a triangle wave. Unlike 2D-RSF-PWM, in conventional SPWM the fundamental frequency of the triangular carrier wave is constant over time. In other words, SPWM uses a constant switching frequency. Controlling the switches using SPWM generates spikes in the inverter output voltage at the switching frequency and its harmonics, and these spikes appear as EMI noise at frequencies at the switching frequency and its harmonics.

One conventional approach to address the EMI noise peaks is to add bulky, lossy, and/or costly EMI filters at the input of the inverter. Another conventional approach to mitigating the EMI generated by conventional SPWM is to use random switching frequency PWM (RSF-PWM), which reduces the amplitude of the EMI spikes at the output of the inverter by distributing the noise throughout the frequency spectrum. Although this approach may reduce the EMI at the switching frequency and its harmonics (which are relatively high frequencies), conventional RSF-PWM increases the noise in the inverter output at lower frequencies. For example, conventional RSF-PWM may increase the amount of noise between about 2 kHz to 150 kHz.

On the other hand, the 2D-RSF-PWM approach, which is implemented in the modulation control system 240, decreases the EMI caused by the voltage harmonics at one or more target frequencies (ftgt) by optimizing two control parameters that are not used in the conventional SPWM and RSF-PWM approaches: the spread factor (δ) and the number of repetitions (k). Thus, a power electronic converter controlled using the 2D-RSF-PWM approach may be implemented with a smaller EMI input filter or with no EMI input filter while still reducing the noise at the output of the inverter.

Referring again to FIG. 6, the process 600 may be performed by the modulation control system 240. The process 600 is discussed with respect to the inverter 219 to provide an example. However, the process 600 may be performed by a control system coupled to an inverter other than the inverter 219.

One or more target frequencies (ftgt) are identified (610). The target frequencies are frequencies at which noise in the output of the inverter 219 is to be reduced or eliminated. As discussed above, the switches S1 to S6 in the inverter 219 are controlled in a switching pattern that is defined by the control signal 241. The control signal 241 for the 2D-RSF-PWM approach is a pulse train that may be expressed as shown in Equation (4):

$${g}_{n} ( t ) = \{ \begin{matrix}0 , t \leq {t}_{n} + \frac{{T}_{n} - {D}_{n} {T}_{n}}{2} \\ A , {t}_{n} + \frac{{T}_{n} - {D}_{n} {T}_{n}}{2} \leq t \leq {t}_{n} + \frac{{T}_{n} + {D}_{n} {T}_{n}}{2} \\ 0 , t > {t}_{n} + \frac{{T}_{n} + {D}_{n} {T}_{n}}{2}\end{matrix} , \qquad Equation ( 4 )$$

$$g ( t ) = {lim}_{n \to ∞} {\sum }_{n = 1}^{N} {g}_{n} ( t ) , \qquad Equation ( 5 )$$

where g(t) is the control signal 241 over time, N is the total number of pulse trains of the control signal 241 generated by comparing the reference signal and the carrier signal, n is an integer that indexes the switching signal of the pulse train; A is the amplitude of the control signal 241 in the ON state; Dn is the width of the modulated signal for the nth switching signal; Tn=1/fn is the time period of the nth switching signal; fn is the nth switching frequency; and tn is the start point of the Tn time period.

By applying the Wiener-Khintchine theorem, the power spectral density (PSD) of the control signal 241 (g(t)) is determined by:

$$G ( ω ) = {\int }_{- ∞}^{+ ∞} g ( t ) {e}^{- j ω t} d t = {\int }_{- ∞}^{+ ∞} g ( t ) cos ( ω t ) dt - j {\int }_{- ∞}^{+ ∞} g ( t ) sin ( ω t ) dt . \qquad Equation ( 6 )$$

To minimize or eliminate a target frequency (ftgt) component from the output voltage of the inverter 219, the PSD of the control signal 241 at the target frequency (ftgt) is zero:

$$0 = G ( {ω}_{tgt} ) = {\int }_{- ∞}^{+ ∞} g ( t ) cos ( {ω}_{tgt} t ) dt - j {\int }_{- ∞}^{+ ∞} g ( t ) sin ( {ω}_{tgt} t ) dt . \qquad Equation ( 7 )$$

To minimize or eliminate noise at the target frequency (ftgt), the following condition should be satisfied:

$$c ( {f}_{tgt} ) = {\int }_{- ∞}^{+ ∞} g ( t ) sin ( 2 π {f}_{tgt} t + φ ) dt = 0. \qquad Equation ( 8 )$$

Substituting Equation (4) and (5) into (8) allows c (ftgt) to be expressed as:

$$\frac{A}{{ω}_{tgt}} {\sum }_{m = 1}^{∞} cos [ {ω}_{tgt} ( {t}_{m} + \frac{\frac{1}{{f}_{m}} - \frac{{D}_{n}}{{f}_{m}}}{2} ) + φ ] - \frac{A}{{ω}_{tgt}} {\sum }_{m = 1}^{∞} cos [ {ω}_{tgt} ( {t}_{m} + \frac{\frac{1}{{f}_{m}} + \frac{{D}_{n}}{{f}_{m}}}{2} ) + φ ] = c ( {f}_{tgt ) .} \qquad Equation ( 9 )$$

As discussed above, the frequency of the reference waveform (ref) is much smaller than the nominal carrier frequency (fc) 249, thus the variation of the amplitude of the reference waveform (ref) is negligible compared to the variation of the amplitude, and the switching frequency (fn) should be selected such that the nth term of the left summation of Equation (9) and the (n+k)th term of the right summation in Equation (9) cancel out. Thus, for each n, the condition shown in Equation (10) is satisfied:

$$\frac{A}{{ω}_{tgt}} {\sum }_{m = 1}^{∞} cos [ {ω}_{tgt} ( {t}_{n} + \frac{\frac{1}{{f}_{n}} - \frac{{D}_{n}}{{f}_{n}}}{2} ) + φ ] - \frac{A}{{ω}_{tgt}} {\sum }_{m = 1}^{∞} cos [ {ω}_{tgt} ( {t}_{m} + \frac{\frac{1}{{f}_{n + k}} + \frac{{D}_{n + k}}{{f}_{n + k}}}{2} ) + φ ] = 0 , \qquad Equation ( 10 )$$

$$where$$

$${t}_{n + k} = {t}_{n} + {\sum }_{m = n}^{n + k - 1} \frac{1}{{f}_{m}} , \qquad Equation ( 11 )$$

$$and$$

$$2 π {f}_{tgt} ( {t}_{n} + \frac{\frac{1}{{f}_{n}} - \frac{{D}_{n}}{{f}_{n}}}{2} ) + φ + 2 κ π = 2 π {f}_{tgt} ( {t}_{n + k} + \frac{\frac{1}{{f}_{n + k}} ∓ \frac{{D}_{n + k}}{{f}_{n + k}}}{2} ) + φ . \qquad Equation ( 12 )$$

By substituting Equation (11) into Equation (12), the switching frequency fₙ₊ₖ to minimize or remove the PSD at the target frequency (ftgt) is:

$${f}_{n + k = \frac{{f}_{tgt} ( 1 + {D}_{n + k} )}{2 κ + \frac{{f}_{tgt}}{{f}_{n}} ( 1 - {D}_{n} ) - 2 {\sum }_{m = n}^{n + k - 1} \frac{{f}_{tgt}}{{f}_{m}}}} , \qquad Equation ( 13 )$$

where k is the number of repetitions 248 of the carrier frequency, and K is an integer number that is inversely proportional to the value of the switching frequency fₙ₊ₖ and is proportional to the range of frequencies 352. By increasing the value of K, the value of the switching frequency is decreased and the range of frequencies 352 is increased (in other words, the difference between fmin and fmax is increased). Thus, the 2D-RSF-PWM approach may be achieved by changing the value of the number of repetitions (k) 248 and the factor of K (which is inversely proportional to the switching frequency).

The 2D-RSF-PWM uses two parameters, the spread factor (δ) 247 and the number of repetitions of the carrier waveform (k) 248, to reduce or eliminate the noise at the target frequency:

$$δ = \frac{Δ {f}_{c}}{{f}_{c}} \qquad Equation ( 15 )$$

$${f}_{rep} = \frac{{f}_{c} [ n ]}{k} , \qquad Equation ( 16 )$$

where frep is the frequency of change of carrier frequency variation and fc (n) is the most recently selected switching frequency. The spread energy band (B) of the output voltage of the inverter 219 around the nominal carrier frequency (fc) when the 2D-RSF-PWM approach is applied is:

$$B h = h δ {f}_{c} + \frac{{f}_{c}}{k} , \qquad Equation ( 17 )$$

where h is the harmonic order of the nominal carrier frequency (fc).

The values of the spread factor (δ) 247 and the number of repetitions (k) 248 are optimized (620). For example, the values of the spread factor (δ) 247 and the number of repetitions (k) 248 may be selected such that the spread energy band (B) at the output voltage of the inverter 219 at one or more harmonics of the nominal carrier frequency (fc) meets a specification or target value

After the values of the spread factor (δ) 247 and the number of repetitions (k) 248 are optimized or selected, the control signal 241 is generated based on the 2D-RSF-PWM approach (630). For example, the control signal 241 may be generated by using the determined values of the spread factor (δ) 247 and the number of repetitions (k) 248 along with the nominal carrier frequency (fc) as discussed above with respect to the process 400.

The control signal 241 is provided to the inverter 219 (640). Applying the control signal 241 to the inverter 219 causes the switches S1 to S6 to switch in a random pattern at a switching frequency that varies over time according to the value of (k) and within a limited range of switching frequencies that depends on the spread factor (δ) and the nominal carrier frequency (fc). The switching pattern dictated by the control signal 241 results in lower noise at the output of the inverter 219 than a switching pattern dictated by a control signal generated using a conventional PWM approach.

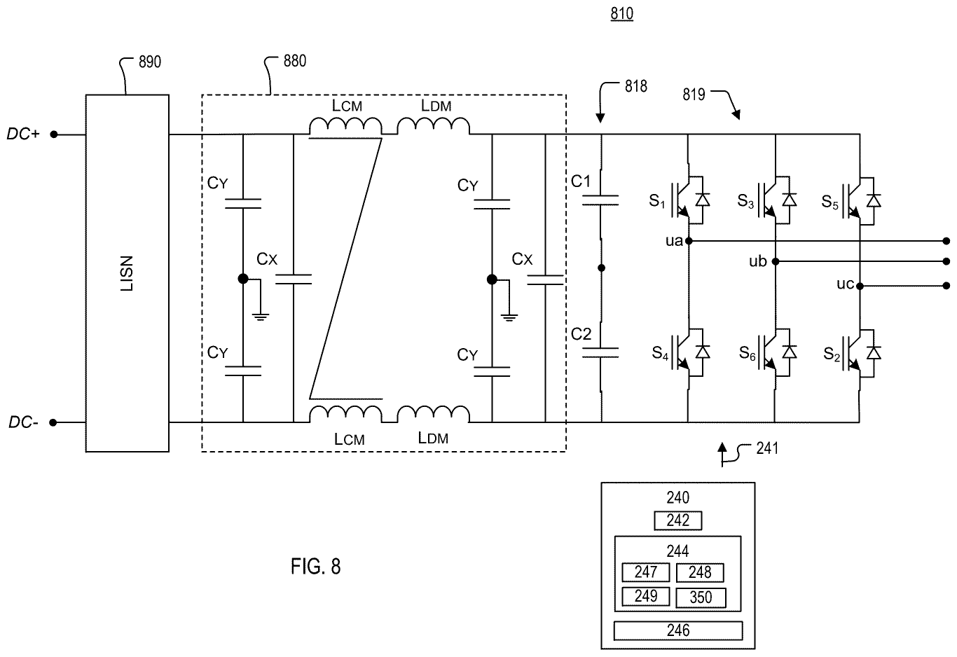

FIG. 7 is plot of amplitude of output voltage noise spikes as a function of frequency for a conventional SPWM approach (dashed line), a conventional RSF-PWM approach (dash-dot line), and the 2D-RSF-PWM approach (solid line). As shown, the conventional SPWM approach results in noise spikes at the carrier frequency (fc) and at harmonics (h) of (fc). The conventional RSF-PWM spreads the noise out throughout the frequency spectrum. The 2D-RSP-PWM approach spreads the noise about a limited frequency band (B) such that the amplitude of the noise is lower than in the SPWM approach. The width of the limited frequency band (B) is determined by the value of the spread factor (δ) and the nominal carrier frequency (fc). Moreover, the 2D-RSP-PWM approach eliminates noise at the target frequencies between the noise bands 701 and 702.

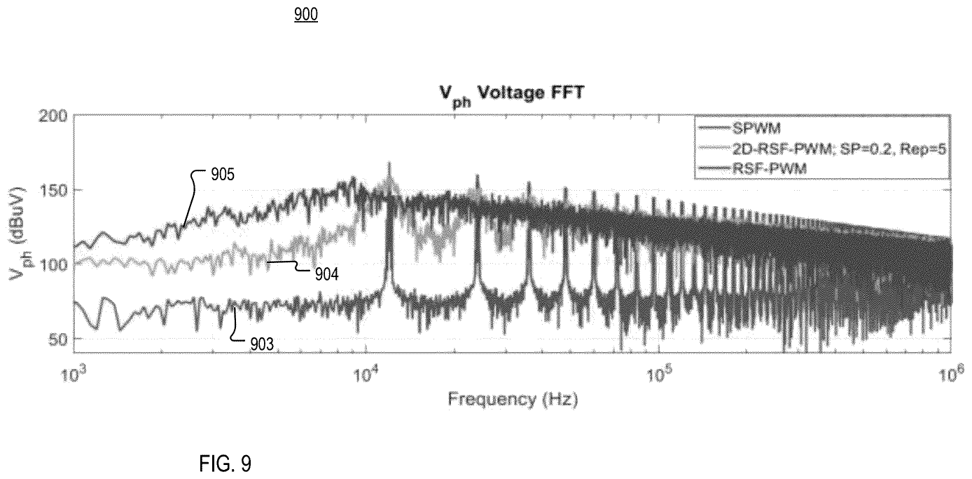

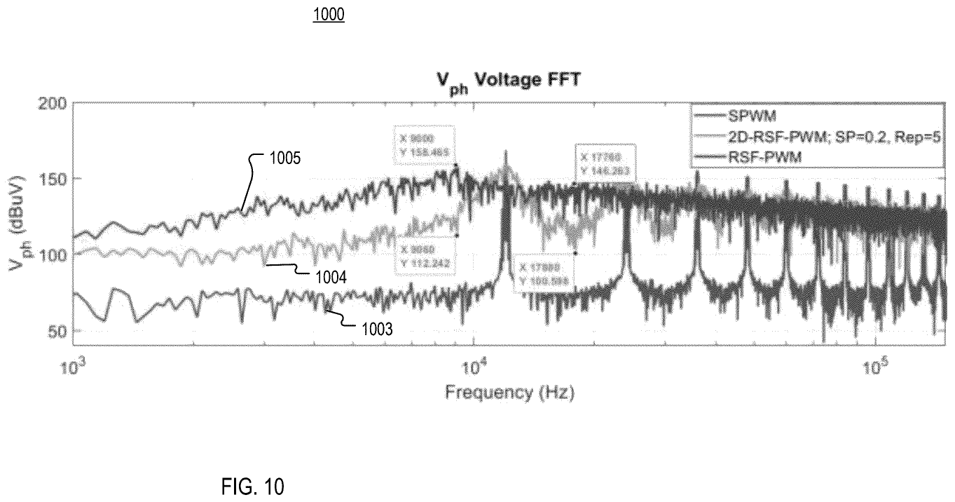

FIGS. 8-10 relate to experimental results. FIG. 8 is a schematic of a VFD 810 used to produce the experimental results shown in FIGS. 9 and 10. The VFD 810 includes a two-level inverter 819 that is electrically connected to a DC link 818. The two-level inverter 819 includes controllable switches S1 to S6, each of which is an IGBT transistor. The switches S1 to S6 switch in a switching pattern defined by a control signal 241 to produce a three-phase output voltage (ua, ub, uc) having characteristics determined by the control signal 241.

The DC link 818 includes a capacitor C1 in series with a capacitor C2. The DC link 818 is electrically connected to an input EMI filter 880. The EMI filter 880 includes capacitors C_{X} and C_{Y} and inductors L_{CM} and L_{DM} arranged as shown in FIG. 8. The VFD 810 has a DC input and a low-pass filter (such as a line impedance stabilization network) between the DC input and the EMI filter 880.

FIGS. 9 and 10 show experimental data collected using the VFD 810. During the experiment, the voltage across the DC link 818 was 680 VDC and the capacitance of the DC link 818 was 1100 microfarads (μF). The fundamental frequency of VFD was 60 Hz, and the main carrier frequency (fc) was 12 kHz. The modulation control system 240 generated the control signal 241 using the 2D-RSF-PWM approach with the spread factor (δ) set to 0.2 and the number of repetitions (k) set to 5. As noted above, the main carrier frequency (fc) was 12 kHz. The reference wave (ref) was a time-varying waveform with the same fundamental frequency as the VFD 810 (60 Hz in this example). The modulation control system 240 also generated versions of the control signal 241 generated using conventional SPWM and conventional RSF-PWM to compare the approaches.

FIG. 9 shows the frequency spectrum of the output phase voltage of the VFD 810 (that is, ua, ub, uc) when using the conventional SPWM approach (labeled 903), the conventional RSF-PWM approach (labeled 905), and the 2D-RSF-PWM approach (labeled 904). The frequency range in FIG. 9 is 1 kHz to 1 MHz. As shown, the maximum amplitude of switching noise of the output voltage with the 2D-RSF-PWM approach is about 10 decibels (dB) lower than with the SPWM approach.

FIG. 10 shows the frequency spectrum of the output phase voltage of the VFD 810 when using the conventional SPWM approach (labeled 1003), the conventional RSF-PWM approach (labeled 1005), and the 2D-RSF-PWM approach (labeled 1004). The frequency range in FIG. 10 is 1 kHz to 200 kHz. As shown in FIG. 10, applying the 2D-RSF-PWM approach reduces the switching noise at the low frequency range and between the multiples of the main carrier frequency (fc) by up to 46 dB as compared to the RSF-PWM approach. Furthermore, by applying the proposed 2D-RSF-PWM method, the current total harmonic distortion (THD) value is reduced by 2.74% in comparison to the output current THD when the RSF-PWM method was applied. Table 1 summarizes the comparison.

TABLE 1

| Parameter | Approach | Value |
|---|---|---|
| Switching Noise at the Output | SPWM | 138 dBμV |
| Voltage @ 150 kHz | RSF-PWM | 129 dBμV |
| | 2D-RSF-PWM | 129 dBμV |
| Output Current THD | SPWM | 6.46% |
| | RSF-PWM | 9.34% |
| | 2D-RSF-PWM | 6.60% |

Because the 2D-RSF-PWM approach reduces the switching noise in the output voltage of the inverter 819 at 150 kHz, the input EMI filter 880 can be implemented with smaller inductors and capacitors, thereby reducing the size and cost of the input EMI filter 880 while also maintaining a similar THD as the SPWM approach. The values of components of the input EMI filter 800 for the 2D-RSF-PWM approach and the SPWM approach are shown in Table 2. As seen in Table 2, the inductors L_{CM} and L_{DM} are about three times smaller when using the 2D-RSF-PWM that when using the conventional SPWM method.

TABLE 2

| Approach | Parameter | Value(s) | |
|---|---|---|---|
| 2D-RSF-PWM | L_{CM} | 1.5 | mH |
| | L_{DM} | 15 | μH |
| | C_{Y} | 3.3 | nF |
| | C_{X} | 1 | μF |
| SPWM | L_{CM} | 4.5 | mH |
| | L_{DM} | 45 | μH |
| | C_{Y} | 3.3 | nF |
| | C_{X} | 1 | μF |

These and other implementations are within the scope of the claims.

What is claimed is:

1. A system comprising:
a power electronic converter comprising controllable electronic switches; and
a control apparatus configured to:
determine a range of carrier frequencies based on a main carrier frequency and a spread factor, wherein the spread factor is value that is not equal to one;
generate a control signal comprising a variable switching frequency, wherein the variable switching frequency has a first switching frequency value in a range of carrier frequencies, and, after a pre-determined number of cycles at the first switching frequency value, the variable switching frequency has a second switching frequency value in the range of carrier frequencies; and
provide the control signal to the power electronic converter such that the controllable electronic switches change state at the variable switching frequency.

2. The system of claim 1, wherein the spread factor is a value that is less than one and the pre-determined number of cycles is greater than one.

3. The system of claim 1, wherein the range of carrier frequencies is centered on the main carrier frequency.

4. The system of claim 1, wherein the first switching frequency value and the second switching frequency value are different.

5. The system of claim 1, wherein the control apparatus is further configured to:
determine the first switching frequency value by randomly selecting a first frequency in the range of frequencies; and
determine the second switching frequency value by randomly selecting a second frequency in the range of frequencies.

6. The system of claim 1, wherein the power electronic converter comprises a variable frequency drive.

7. The system of claim 1, wherein the power electronic converter comprises a multi-level converter.

8. The system of claim 1, wherein the power electronic converter comprises a two-level converter.

9. The system of claim 1, wherein the control apparatus is further configured to:
access a value representing an acceptable spread energy band of one or more harmonics of an output voltage of the power electronic converter; and
determine the spread factor and the pre-determined number of cycles based on the main carrier frequency and the value representing the acceptable spread energy band.

10. The system of claim 1, wherein the power electronic converter comprises a rectifier, a DC link, and an inverter.

11. A modulation control system for a power electronic converter, the modulation control system configured to:
generate a control signal comprising a variable switching frequency, wherein the variable switching frequency has a first switching frequency value in a range of carrier frequencies, and, after a pre-determined number of cycles that is greater than one, the modulation control system is configured to set the variable switching frequency to a second switching frequency value in the range of carrier frequencies, and wherein the range of carrier frequencies is based on a spread factor and a main carrier frequency.

12. The modulation control system of claim 11, wherein the modulation control system is further configured to provide the control signal to a power electronic converter such that controllable electronic switches in the power electronic converter change state at the variable switching frequency.

13. The modulation control system of claim 11, wherein the modulation control system is further configured to determine the range of carrier frequencies based on the main carrier frequency and the spread factor, and wherein the spread factor is value that is not equal to one.

14. The modulation control system of claim 11, wherein the spread factor is a value that is less than one and the pre-determined number of cycles is greater than one.

15. The modulation control system of claim 11, wherein the modulation control system is further configured to:
access a value representing an acceptable spread energy band of one or more harmonics of an output voltage of the power electronic converter; and
determine the spread factor and the pre-determined number of cycles based on the main carrier frequency and the value representing the acceptable spread energy band.

16. A method of decreasing noise in an output voltage of an inverter at one or more target frequencies, the method comprising:
accessing one or more target frequency values;
accessing a value representing an acceptable spread energy band at the one or more target frequency values;
determining a spread factor and cycle count (k) based on a main carrier frequency and the value representing the acceptable spread energy band;
generating a control signal for an inverter, the control signal comprising a variable switching frequency that changes each cycle count (k) repetitions based on the spread factor and a main carrier frequency; and
providing the control signal to the inverter to thereby decrease the noise in the output voltage of the inverter at the one or more target frequencies.

17. The method of claim 16, wherein at least one of the one or more of the target frequency values is less than 150 kHz.

18. The method of claim 16, wherein at least one of the one or more of the target frequency values is between 20 kHz and 150 kHz.

19. The method of claim 16, wherein at least one of the one or more of the target frequency values is between 2 kHz and 150 kHz.
